(19) United States
(12) Patent Application Publication
(10) Pub. No.: US 2004/0074450 A1
(43) Pub. Date: Apr. 22, 2004

(54) Dog diaper

(76) Inventors: Daryl Bruce Soares, Honolulu, HI (US); Leslea Ann Soares, Honolulu, HI (US)

Correspondence Address: BRIAN D. BELLAMY, P.O. BOX 1997, THOMASVILLE, GA, 31799-1997, US

(21) Appl. No.: 10/431,227

(22) Filed: May 7, 2003

Related U.S. Application Data
(63) Continuation-in-part of application No. 09/974,229, filed on Oct. 10, 2001, now abandoned.

(51) Int. Cl. A01K 13/00

(52) U.S. Cl. 119/850

(57) ABSTRACT

A diaper for a dog or other animal comprises a body band of sufficient length to be placed around the body of a dog that includes a fastening device such as Velcro to secure the body band about the waist of the dog. An elongate covering with stiffening member extends from the mid-section of the body band that is of sufficient length to cover the dog's genital area without overlapping the dog's anal area. Thus, normal bowel movement is not inhibited. The body band and the elongate covering are constructed of an inner layer consisting of a non-allergenic fabric to be disposed against the body and the genital area of the dog, a decorative outer layer to be exposed, and a moisture impermeable layer situated between the inner layer and outer layer to trap waste discharge. A pair of straps constructed of elastic material connect the body band to the elongate covering and maintain the covering and mid-section of the body band over the dog's genital area. A disposable or reusable absorbent pad may be affixed to the inner surface of the elongate covering and body band to rest against the dog's genital area when the diaper is worn by the dog. A chest cover extends from the forward edge of the body band for covering a portion of the dog's chest area. A pair of tie straps or fastening device attaches the chest cover about the neck of the dog and further secures the diaper on the dog so that the diaper cannot be easily removed by the animal.

### PRIORITY CLAIM

The present application is a continuation in part of U.S. patent application Ser. No. 09/974,229 filed on Oct. 10, 2001 and claims benefit of priority thereof.

### BACKGROUND OF THE INVENTION

1. Field of the Invention

This invention relates to a diaper for dogs and other small animals. The invention is more particularly concerned with a diaper to be held in place on a dog by a detachable band that fastens on the dog's waist at its back, a pair of elastic bands that fit about the dog's rear legs, and a chest garment and tie straps that secure about the dog's chest and neck. The diaper prevents dogs from urinating or menstruating in unwanted areas or causing or becoming impregnated.

2. Discussion of the Prior Art

Waste discharge in undesirable locations is a problem encountered with many pets, particular dogs. Urination and menstruation with female dogs are particularly messy and difficult to clean forms of waste discharge that pose the most significant problems to dog owners with respect to discharge on improper sites. Whether caused by improper training or accident, a dog may urinate in undesirable locations in the home such as on furniture, bedding, carpet, and upholstery, or in other undesirable venues such as in an automobile. Urination in improper locations may become especially problematic with dogs that are very young, effected by advanced age, have a medical condition such as incontinence, lack training, or are left unattended for extended periods. The problems associated with dog urination and menstruation have been long recognized and many attempts have been made to provide a dog diaper to address these problems. Attempts have also been made to address the bowel movements of dogs. However, bowel movements do not generally pose the same day to day problems of soiling in the home or automobile that urination or menstruation do, and most attempts to address the bowel movements of dogs have resulted in dog diapers that are less comfortable for the wearing animal.

Further, dog owners have made some attempts to address the problem of preventing unwanted pregnancy. The owner of a male dog that impregnates a female dog may be subject to liability or embarrassment. In some cases additional safeguards, such as a dog diaper, may be needed to prevent unwanted pregnancies, particularly where fixing the pet is not a good option because of breeding or medical needs.

Thus, a needs continues to exist for improved dog diapers that provide ease of use and functionality, low cost to manufacture, or comfort of the animal wearer. With regard to ease of use, the diaper should be reusable or disposable and should be easy to attire onto a dog and easy to subsequently remove. The attired dog diaper should be difficult for the animal to remove or adjust against the master's wishes. Further, the dog diaper should not hinder the movement of the dog, and a design is needed for preventing urination and menstruation in undesirable locations that does not hinder the regular bowel movement of the dog outside the diaper.

The prior art reflects a variety of diaper-like garments for dogs intended to address one or more of the problems discussed. See, for example, U.S. Pat. No. 6,142,105 to McKnight (securely fitting pet diaper); U.S. Pat. No. 4,577,591 to Wesseldine (incontinence and protective device for animals); U.S. Pat. No. 4,917,683 to Thompson (canine seasonal panties); U.S. Pat. No. 4,813,949 to O'Rourke (dog diaper); U.S. Pat. No. 5,555,847 (dog diaper); U.S. Pat. No. 5,945,015 to Ohta (disposable diaper for animals and method of manufacture); and U.S. Pat. No. 4,996,949 to Wunderman et al. (disposable dog diaper).

The known devices and garments illustrated by the foregoing patents are subject to one or more short-comings with respect to ease of use and functionality, cost to manufacture, or comfort of the animal wearer. For instance, several of the preexisting dog diapers have multiple devices to attach about the dog before the diaper is fully secure, thus making application cumbersome. Others of the preexisting dog diapers have a small hole in the diaper to accommodate a dog's tail, which is difficult to secure and also restricts bowel movements. Thus, despite the many diaper-like devices that have been designed for dogs, a need still exists for a dog diaper that is easy to apply and remove that securely fits on a dog and functions well. A well-designed dog diaper should also be fashionable and stylish and potentially provide additional benefits such as keeping the pet warm during cold days.

### SUMMARY OF THE INVENTION

My invention provides a dog diaper comprising a body band constructed of non-allergenic fabric, a elongate covering with a stiffening member extending from the mid-section of the body band, a pair of straps attaching the body band to the elongate covering, a chest cover, and a fastening device attached to the chest cover for fastening about the animal's neck. The straps provide leg openings, and to diaper a dog, the dogs legs are inserted into the leg openings, and the body band of the diaper attaches about a dog's body at the waist and fastens at the dog's back. The straps pull the elongate covering rearward between the dog's legs to position the mid-section of the body band and elongate covering over the genital area of the dog. The chest cover is pulled forward under the animal to cover its chest and secured there by affixing the fastening device at the animal's neck. The anal area of the dog is left uncovered to allow regular uninhibited bowel movements by the dog, while protecting from undesirable urination or menstruation by the dog in household areas or the like. Further, the sexual genitals of a male or female dog wearing the diaper are covered to prevent unwanted sexual contact and pregnancy. A disposable or reusable absorbent pad may be affixed to the inner surface of the diaper to enhance its function. The dog diaper of the present invention provides a highly effective diaper for protection against undesirable urination or menstruation and has only one fastening area, making the diaper very cost effective to construct and easy to use.

### BRIEF DESCRIPTION OF THE DRAWINGS

FIG. 1 is a plan view of an embodiment of the dog diaper of the invention showing the inside surface areas.

FIG. 2 is a perspective view of an embodiment of the dog diaper of the invention showing the body strap ends shown connected to each other.

FIG. 3 is a perspective view of a dog wearing the dog diaper of FIGS. 1 and 2.

FIG. 4 is a sectional layered plan view of an embodiment of the dog diaper of the invention.

### DETAILED DESCRIPTION OF THE INVENTION

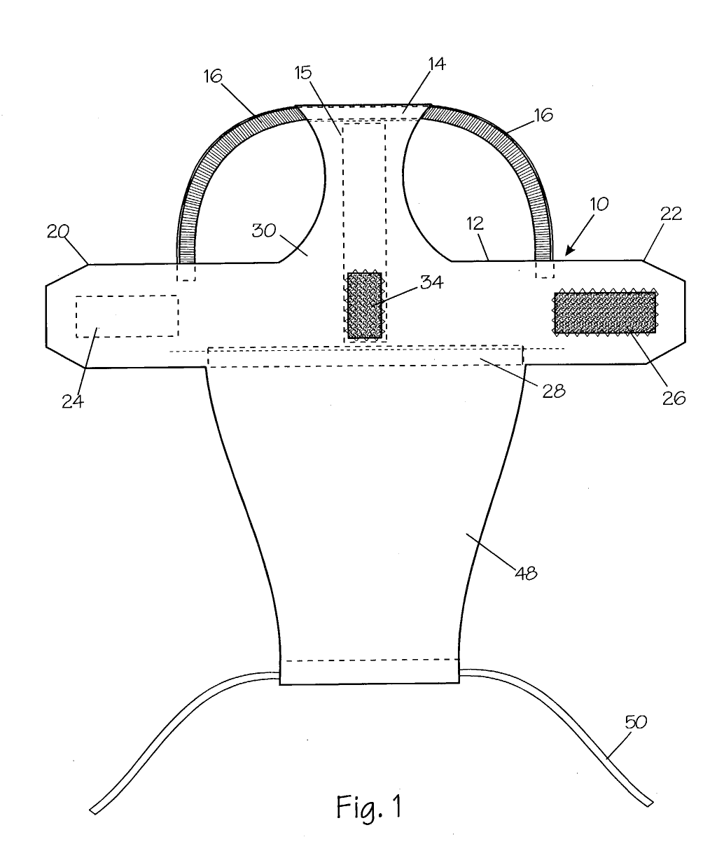

Referring to FIG. 1, a preferred embodiment of the invention is shown in the form of a securely fitting dog garment or diaper 10. The diaper may be provided in different sizes and can be used with any type of dog or any other small pet, such as a cat, having a similar body structure to a dog. The diaper 10 includes a body band 12, an elongate covering portion 14, a pair of straps 16, a chest cover 48, and a fastening device 50. The body band 12, elongate covering 14, and chest cover 48 are each generally made of textile fabric material, preferably a fabric such as cotton that is non-allergenic, and the straps 16 are each generally made of elastic material.

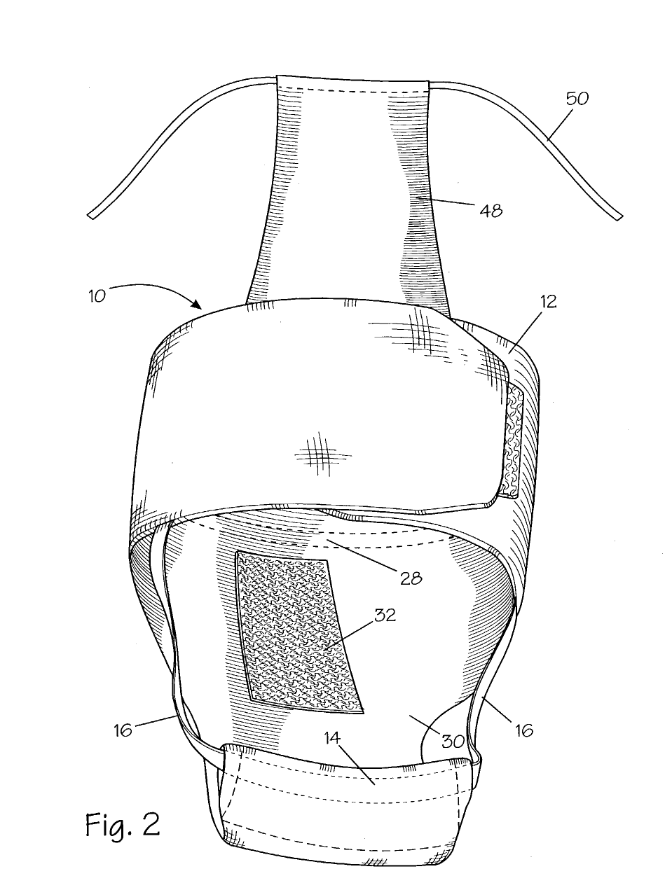

The body band 12 of the diaper 10 provides an elongate band having sufficient length to stretch about the waist of the body of a dog of a determined size. The body band 12 may be constructed in various lengths and widths to accommodate various size dogs. The first and second ends 20 and 22 of the body band 12 attach to each other to secure the diaper 10 on the dog. Therefore, the body band 12 as shown in the preferred embodiment includes fastening devices on the ends 20 and 22 such as hook and loop pile material or VELCRO patches 24 and 26. The hook and loop patches 24 and 26 mate when the ends 20 and 22 of the body band 12 are brought together as shown in FIG. 2 to secure the diaper 10. Other fastening devices such as snaps could be provided rather than hook and loop to secure the body band 12. However, hook and loop pile material has proven to be easy and cost effective. An elastic material 28 may be provided in the body band 12 to enhance the secure fit of the band 12. In FIG. 1, the elastic material 28 is shown in the mid-section 30 of the band 12 sewn into the edge of the band 12.

The straps 16 attach to the body band 12 and the elongate covering 14 to form a pair of leg holes 18 for the rear legs of a dog. Like the body band 12, the straps 16 may be constructed of various lengths to accommodate various size dogs. The straps 16 are each attached near opposing ends of the body band 12 and are positioned such that the ends of the straps 16 attached to the body band 12 are located on the back of the dog or the upper portion of the dog's sides when the diaper is secured to the dog. The other ends of the straps 16 each attach to the end of the elongate covering 14. Thereby, the straps 16 operate to further secure the diaper 10 on the dog and also function to pull the elongate covering 14 and secure the elongate covering 14 over the rearward portion of a dog's underside and, in particular, a female dog's genital area. The straps 16 are preferably elastic to accommodate variations in the size and shape of dog and provide comfort to the animal while wearing the diaper 10.

As shown in the embodiment of FIG. 1, the elongate covering 14 may be shaped to fit the contours of a dogs legs, which promotes proper fit for the diaper 10 and prevents leaking. The length of the elongate covering 14 may be varied, but will preferably have sufficient length to cover the genitals of a female dog when worn. Thus, the elongate pad 14 provides protection against the diaper 10 leaking and, in particular, provides a diaper 10 that protects against urination or menstruation by female dogs. To provide additional support to the structure of the elongate covering 14, a stiffening member 15 is provided within the elongate covering 14. The stiffening member 15 may consist of a plastic rib that is substantially sturdier than the fabric of the elongate covering 14. The stiffening member 15 will prevent the diaper from collapsing about the dog's waist.

An optional absorbent pad 32 may be removably attached to the elongate covering 14 and body band 12. In the embodiment of FIG. 1, a hook and loop patch 34 is fixed to the inner surface of the body band 12 to receive a detachable absorbent pad, wherein a washable absorbent pad having a complementary hook and loop attaching device may be affixed to the patch 34. Alternatively, a surface for receiving an adhesive could be provided on the inner surface of the body band 12, and a disposable pad having an adhesive backing could be affixed to the inner surface of the body band 12. Further variations of manners in which an absorbent pad 32 may be provided on the inner surface of the elongate covering 14 and body band 12 exist and the specific manner of implementation is not critical.

A chest cover 48 and neck fastening device 50 is provided for additional adornment of the pet and to inhibit removal of the diaper by the animal 36. The chest cover 48 is attached to the mid-section 30 of the body band 12 and is situated on the pet to stretch forward beneath the pet along the chest area. Once pulled forward, the chest cover 48 adorns at least a portion of the animal's chest. The fastening device 50 maintains the position of the chest cover 48 about the animal's chest by attaching the chest cover to the animal's neck area. In the embodiment shown in FIG. 3, the fastening device 50 consists of a pair of tie straps that are pulled over the top of the animals neck and tied in a knot. A well-tied knot in combination with the body band 12 situated about the animal will completely prevent most domesticated dogs from removing the diaper through efforts of pushing, pulling or shaking. Alternative fastening devices could be employed in substitution for the tie straps, such as attached collars, straps with VELCRO or other coupling device, or devices for coupling the chest cover to an existing collar.

While providing protection against urination by both male and female dogs, the present dog diaper provides a construction that does not inhibit the natural bowel movements of a dog, making the present diaper advantageous for use by owner's of household pets who are concerned with protecting against urination or menstruation problems, or unwanted sexual contact between pets. As shown in FIG. 3, the diaper 10 is secured about the waist of the dog 36 by the body band 12 and secured about the neck of the dog the fastening device 50. The straps 16 pull the elongate covering 14 rearwardly between the dog's 36 legs 38 and 40. The straps 16 are spatially separated and spread apart by their attachment near opposing ends of the body band 12. Further, the elongate covering 14 is limited to a desired length that does not overlap the anal area of the dog, thus not interfering with bowel movements.

As can be seen in FIG. 3, the diaper 10 is easily placed on a dog 36 by placing a strap 16 about each leg 38 and 40 of the dog, slipping the body band 12 beneath the torso of the dog, and then attaching the body band 12 on the back of the dog with the hook and loop patches 24 and 26 or other attaching device or means. After the body band 12 portion of the diaper is secured, the tie straps or other fastening device 50 is easily ties or coupled about the dog 36 or animal's neck area.

In the preferred embodiment, the body band 12 and elongate covering 14 are constructed of at least three layers of material. First, an inner layer 42 is provided to be disposed against the body and genitals of the dog and preferably consists of a non-allergenic fabric. The inner layer should be very comfortable to the animal wearing the diaper 10. Second, an outer layer 44 is constructed of a textile material and is provided to be exposed and seen. The outer layer may be imprinted or provided with decorative features to adorn the dog and appear as a fashionable garment. Finally, a moisture impermeable layer 46 is situated between the inner layer 42 and outer layer 44 to trap waste discharge and prevent the diaper 10 from leaking.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention as defined by the claims.

We claim:

1. A diaper for a dog or other animal comprising:
a. a body band having a first end, a second end, a mid-section, a forward edge of the mid-section, a rearward edge of the mid-section, and of sufficient length to be placed around the body of the dog;
b. an elongate covering extending from the rearward edge of the mid-section of the body band;
c. a first strap connected near the first end of the body band and to the elongate covering and a second strap connected near the second end of the body band and to the elongate covering;
d. a fastening device on the first end or the second end of the body band to secure the body band around the body of the dog;
e. a chest cover extending from the forward edge of the mid-section of the body band; and
f. a fastening device connected to the chest cover.

2. The diaper as in claim 1 in which the body band and the elongate covering include an inner surface for attaching an absorbent pad.

3. The diaper as in claim 1 in which the first strap and the second strap are constructed of elastic material.

4. The diaper as in claim 1 in which an elastic material is sewn into an edge of the body band to enhance the fit of the body band when secured about the body of the dog.

5. The diaper as in claim 1 in which the body band and elongate covering are constructed of at least three layers including an inner layer consisting of a non-allergenic fabric to be disposed against the body and the genital area of the dog, an outer layer to be exposed, and a moisture impermeable layer situated between the inner layer and outer layer to trap waste discharge.

6. The diaper as in claim 5 in which the outer layer in constructed of a decorative textile material.

7. The diaper as in claim 1 in which the elongate covering includes a stiffening member therein.

8. The diaper as in claim 7 in which the stiffening member is a plastic rib.

9. A diaper for a dog or other animal comprising:
a. a body band having a first end, a second end, a mid-section, a forward edge of the mid-section, a rearward edge of the mid-section and having an elastic material sewn into an edge of the body band;
b. an elongate covering extending from the rearward edge of the mid-section of the body band, the body band and the elongate covering constructed of at least three layers including an inner layer consisting of a non-allergenic fabric, an outer layer, and a moisture impermeable layer situated between the inner layer and outer layer;
c. a first strap constructed of elastic material connected near the first end of the body band and to the elongate covering and a second strap constructed of elastic material connected near the second end of the body band and to the elongate covering;
d. a fastening device on the first end or the second end of the body;
e. an inner surface on the body band and the elongate covering for attaching an absorbent pad;
f. a chest cover extending from the forward edge of the mid-section of the body band; and
g. a pair of tie straps connected to the chest cover.

10. The diaper as in claim 1 in which the fastening device connected to the chest cover includes of a pair of tie straps.

11. The diaper as in claim 1 in which the fastening device connected to the chest cover includes a collar.

12. A method of diapering a dog or other animal having two hind legs, a waist, a back, a neck, a chest area, a genital area, and an anal area, comprising the steps of:
a. providing a diaper for a dog having a body band having a first end, a second end, and a mid-section having a forward edge of the mid-section and a rearward edge of the mid-section, and the body band being of sufficient length to be placed around the body of the dog, an elongate covering extending from the rearward edge of the mid-section of the body band of sufficient length to cover the dog's genital area without overlapping the dog's anal area or inhibiting normal bowel movement, a first strap connected near the first end of the body band and to the elongate covering and a second strap connected near the second end of the body band and to the elongate covering, thereby the straps providing leg openings, a fastening device on the first end or the second end of the body band to secure the body band around the waist of the dog, and a chest cover attached to the forward edge of the mid-section of the body band;
b. inserting the dog's two hind legs into the leg openings;
c. placing the body band about the dog's waist;
d. fastening the first end and second end of the body band at the dog's back;
e. situating the elongate covering rearward between the dog's legs to cover the genital area of the dog;
f. leaving the anal area of the dog uncovered;
g. covering a portion of the chest area of the dog with the chest cover; and
h. attaching the chest cover to the neck of the dog via a fastening device.

13. A method of diapering a dog or other animal having two hind legs, a waist, a back, a neck, a chest area, a genital area, and an anal area, as in claim 10 including the steps of providing an inner surface on the elongate covering and attaching an absorbent pad to the inner surface.
